(19) United States
(12) Patent Application Publication
(10) Pub. No.: US 2013/0024309 A1
(43) Pub. Date: Jan. 24, 2013

(54) BARTER CHAINS

(71) Applicant: Tuomas Sandholm, Pittsburgh, PA (US)

(72) Inventor: Tuomas Sandholm, Pittsburgh, PA (US)

(21) Appl. No.: 13/555,576

(22) Filed: Jul. 23, 2012

Related U.S. Application Data
(60) Provisional application No. 61/511,086, filed on Jul. 24, 2011.

(51) Int. Cl. G06Q 30/06

(52) U.S. Cl. 705/26.1

(57) ABSTRACT

Provided is a system, method and program product for facilitating multiple barter transactions between users. Embodiments provide barter chains that begin and end with different participants. Embodiments provide a participant in the barter chain may an altruistic donation expecting nothing in return. Embodiments provide that multiple items of varying value comprise a barter transaction. Embodiments provide that the barter market operator can be a participant and seed the barter chain with one or more items. Embodiments provide that a participant can sell items received or donate them altruistically to start a new barter chain.

### CLAIM FOR PRIORITY

This application claims priority from U.S. Provisional Application No. 61/511,086, filed on Jul. 24, 2011, and which is incorporated by reference as if fully set forth herein.

### FIELD OF THE INVENTION

Embodiments generally contemplate barter systems. More specifically, the invention relates to commercial applications for barter chains.

### BACKGROUND

Barter is a method of trade by which goods or services are directly traded for other goods or services without using a medium of trade, such as money. While one-to-one bartering is practiced between individuals and businesses on an informal basis, organized barter markets have developed to conduct more efficient bartering. A barter market operator facilitates trades between participants. Barter markets (for example, for used commercial goods) operate as follows. In a conventional barter market, each participant lists the items they desire to receive and those that they are willing to trade away. The barter market operator then assists each of the participants by connecting them so that the desirable trades can be accomplished. The first participant trades his items with a second participant and the second participant trades his or her items with the next. The trading continues until the first participant receives the item or item that he desires from another participant. Accordingly, the participant who begins the cycle receives the item or items he desires and the cycle ends. Thus the cycle may be thought of as a circle.

### BRIEF SUMMARY

In summary, one aspect describes a system comprising a processor; a memory in communication with the processor; and computer readable program executable by the processor, the computer readable program code comprising: computer readable program code configured to: receive, store, and process information from two or more participants concerning attributes of items they are interested in giving or receiving; create a barter chain by constructing one or more barter legs that enable, based upon said information, each participant of the chain to accomplish a desired trade, donation, or receipt of one or more items through donation; and display to each of the one or more participants information to accomplish the participant's desired trade, donation, or receipt of one or more items through donation.

Another aspect describes a system comprising: a processor; a memory in communication with the processor; and at least one program product configured to operate in accordance with embodiments.

A further aspect provides a method comprising: receiving at an electronic device information from two or more participants concerning attributes of items for inclusion in a barter chain; processing the information from the two or more participants concerning attributes of the items to associate the items with a barter chain; storing the processed information in a memory device; accessing the processed information in the memory device to create at least a barter leg of a suggested barter chain; said suggested barter chain being including one or more barter legs that comprise one or more of a trade of items, a donation of one or more items, or a receipt of one or more items through donation; and transmitting from the electronic device to the one or more participant devices information for displaying at least a portion of the suggested barter chain. Other aspects are described and claimed.

For a better understanding of embodiments, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

FIG. 1 describes a barter cycle.

FIG. 2 describes a barter chain in accordance with embodiments.

FIG. 3. illustrates an example computer.

### DETAILED DESCRIPTION

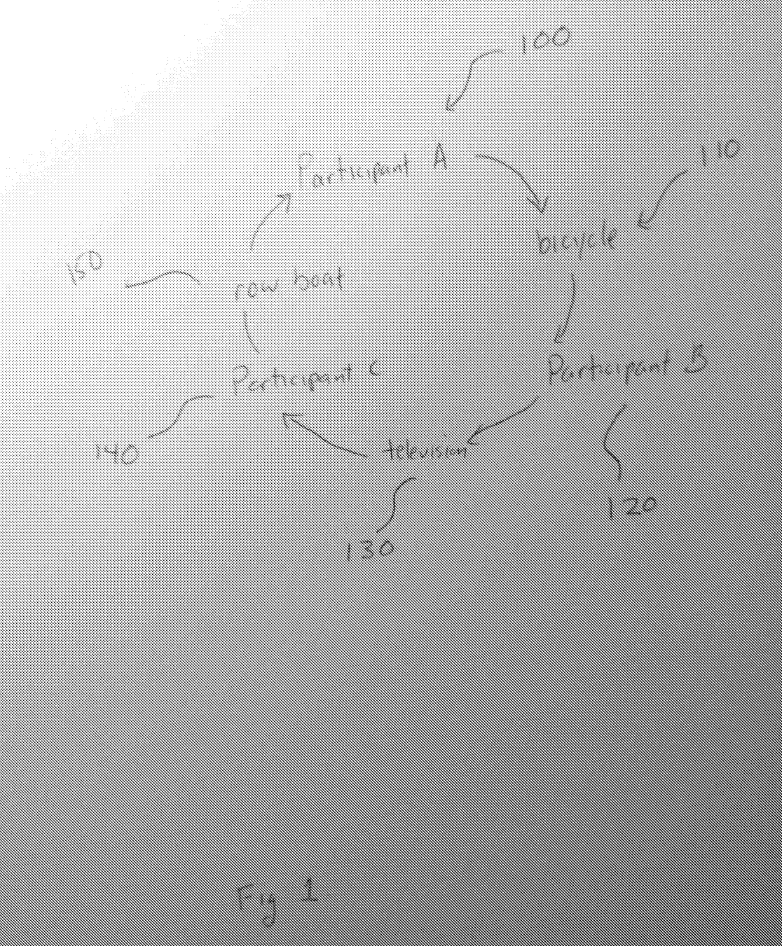

It will be readily understood that the components of the embodiments, as generally described and illustrated in the figures herein, may be arranged and designed in a wide variety of different configurations. Thus, the following more detailed description of the embodiments of the apparatus, system, and method of the present invention, as represented in FIGS. 1 through 3 is not intended to limit the scope of the embodiments of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Barter systems conventionally operate as a cycle. However, a participant (for example, the first participant) may simply give or donate an item and not expect anything in return. Conventional barter systems do not include altruistic donations where the participant does not expect anything material in return. In such an arrangement, the cycle is not completed with the initial participant and thus may be described as a chain (linear as opposed to circular) ending with a different participant than the first. Embodiments describe implementing donations into the barter market or seed donations into the barter market to create such chains.

The illustrated embodiments of the invention will be best understood by reference to the drawings, wherein like parts are designated by like numerals or other labels throughout. The following description is intended only by way of example, and simply illustrates certain selected embodiments of devices, systems, and processes that are consistent with the invention as claimed herein.

The remainder of the disclosure begins with a general overview of the instant invention, and then proceeds to give a more detailed description of preferred embodiments of the invention with reference to the accompanying figures.

Barter markets operating on the internet include United Network for Organ Sharing (UNOS) (http://www.unos.org/). In such barter markets, the barter market operator facilitates the collection and storage of information from various participants about the items that the participants are willing to trade or give away and the items they desire to receive for those trades. Based upon this information, the barter market operator creates cycles of items to be traded from one participant to another.

Turning now to the Figures, FIG. 1 describes a barter cycle having three participants. Here, Participant A is willing to trade a bicycle and would like to receive a row boat. The other participants are each willing to make trades and each is able to benefit from the barter cycle. At 100, Participant A begins the cycle by giving a bicycle at leg 110 to Participant B. At 120, Participant B, receives the bicycle and gives a television at leg 130 to Participant C. At 140, Participant C receives the television and gives a row boat at leg 150 to Participant A. In this way the cycle ends when a participant receives the item(s) they wanted in consideration for the item(s) they traded away. Such cycles may be implemented by computers and attendant program products.

Embodiments provide that a barter market may also be constructed using chains. The barter chain may start with a party that is willing to give out some item without receiving any item(s) in return. Such a party can be, for example, a true altruist, or it can be the barter market operator, itself, seeding the chain with one or more free items, or it could be the last participant giving one or more items he was willing to trade in consideration for the one or more items that he received, to begin a new barter chain. Additionally, embodiments provide that the set of items that the last participant might give to start a new barter chain might include one or more items that he received at the end of a barter chain. Moreover, embodiments provide that there can be multiple barter chains operating in parallel.

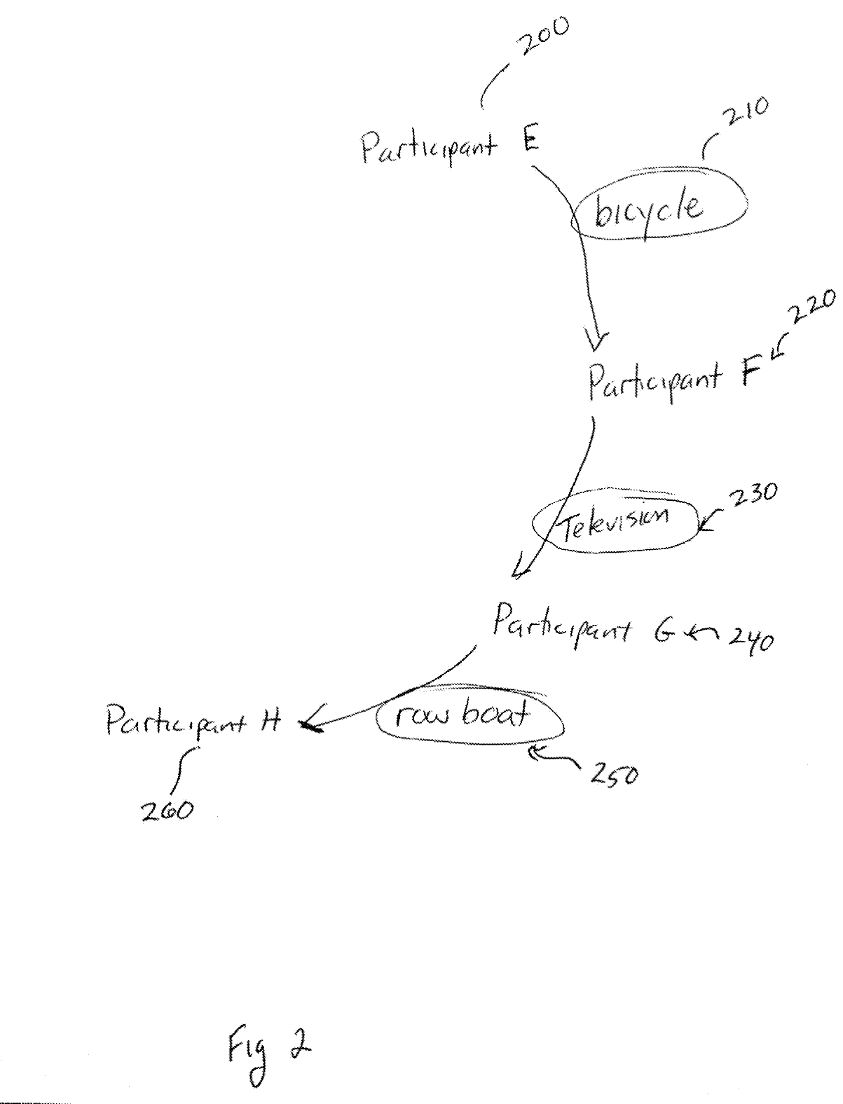

Turning now to FIG. 2, a non-limiting example of barter chain is described. In this example, Participant E merely wishes to donate a bicycle and wants nothing in return. Participant F is willing to trade his television for a bicycle. Participant G is willing to trade his row boat for a television. Participant H is not trading anything but would really like to get a row boat. At 200, Participant E donates a bicycle at leg 210 which is then received by Participant F at 220. Participant F trades television at let 230 which is received by Participant G at 240. Participant G trades a row boat at leg 250 since he has now received the television that he wanted. At 260, Participant H receives the row boat of his desire and he gives nothing in return. Thus, Participant E altruistically provides the trade that starts the chain for the row boat to reach Participant H.

Embodiments provide a system that facilitates these trades by connecting participants and providing necessary information, such as including identity and address of participants, location of item(s), names of item(s), depictions of each item (s), attributes of each item, and options for shipping or pick up of the item(s). According to embodiments, non-limiting examples of attributes for item(s) include make, model, color, size, dimensions, weight, age, and value, type of service, length of service, name of service, name of service provider, etc. According to embodiments, participants may provide information about desired attributes for the items they are seeking to receive or such attributes may be selected through pull-down windows in computer software operating in accordance with embodiments. In other words, items do not have to be specified completely (such as a particular TV) but can be specified using attributes (e.g., a color TV with a screen that is at least 40″ wide, and use at most x Watts of energy). Likewise, participants may provide information about the attributes of the item(s) they are trading or giving away. Participants who are seeking charitable donations may also provide information about the attributes of the item(s) they are seeking through donations. In this way, an embodiment provides systems and methods for collecting, processing, storing, and providing all the information so that the necessary and optimum trades can be accomplished among and between the participants. Likewise participants who are altruists or seeking charitable donations can be connected through a barter chain or chains as appropriate.

Embodiments allow a participant to express multiple pairs of sets of sets of items for trade. In one non-limiting example, the first set of the pair includes sets of items the participant is willing to take and the second set of the pair includes sets of items the participant is willing to give in return. For instance, the participant's first pair is A and A′. A includes taking a boat or taking both a bike and a helmet. A′ includes giving a motorcycle or giving both a computer and a monitor. In a given pair, either set can be empty. The former set being empty means that the participant is willing to give something without expecting anything in return. The latter set being empty means that the participant wants to receive something without giving anything in return.

Embodiments provide an interior of such a chain is like that of a cycle with each participant in the interior of the chain giving some item(s) and receiving some item(s). Embodiments described that each leg of the transaction can involve more than one item. A chain can end in various ways. It will be appreciated that these example chain endings are not meant to be exhaustive and anybody skilled in the relevant art will understand the myriad of endings available for a chain, which are contemplated by the instant disclosure.

Embodiments provide barter legs that may be accomplished contemporaneously, concurrently, or in any other desirable order and there are no constraints on the sequence or number of barter trades contemplated herein. In one non-limiting example returning to FIG. 2, leg 250 could be accomplished before leg 220. Alternatively, leg 250 and leg 220 could be accomplished simultaneously. Embodiments do not limit the sequencing or number of such legs in a barter chain.

In one non-limiting example, an embodiment provides for a chain ending when some participant receives an item without any expectation that participant gives an item. Other embodiments allow the chain to end when the last participant donates his/her item to charity. Still other embodiments provide that the last participant in the chain becomes a “stand-in” altruist to trigger a new chain with at least one item from among the item(s) that he/she would have been willing to give out in trade for the item(s) that he/she received. Other embodiments end the chain with the sale of the item(s) that the last participant in the chain was willing to trade in consideration for the item he received and/or some of the items he received. Other embodiment provide for continuous or new chain formation such that there is not a strict ending to a given chain so much as components or legs thereof have been accomplished.

One skilled in the art will appreciate that the participants may choose to barter multiple items for multiple items or single items for single items or combinations of lower value items to support receiving a higher value item. Embodiments thus permit participants to use any number of items and combination of values to barter.

Embodiments provide that a participant may choose to altruistically donate one or more items of any value in order to seed example barter chains described herein. Thus, an embodiment may receive one or more such seeds, store them, process them in order to appropriately categorize them, and provide them for use in one or more barter chains, as described here, as the other items (sets of sets) are handled. Other embodiments describe that the barter market operator is actually a participant and may provide seed items for the initial chain or ongoing chains or components thereof by donating one or more items, for example, to begin a chain of barter by the rest of the participants. Embodiments further provide that a barter market operator may simply receive charitable donations from others and place them into the barter chain to seed it.

Embodiments provide that each barter transaction does not have to involve one item but can involve multiple items. Further, the number of items given by a participant does not have to equal the number items received by that participant. It will be appreciated that a participant might combine items of lesser value in order to barter for a value of greater value.

Embodiments provide that the barter chains are applicable for trades involving commercial settings such as used goods. Other non limiting examples of the embodiments disclose barter chains involving new goods. Further non-limiting example embodiments describe barter chains applied to intangible rights such as time shares or patent licensing. Still other embodiments involve barter of service for services or services for goods or donation of services. The combination and types of items are unlimited. Embodiments provide that the persons or entities receiving items may be in or outside of one or more barter chains. Thus, non-participants may receive items.

As a non-limiting example, an embodiment may receive (for example, via transmission over a network connection, such as the Internet or a WAN/telecommunications network, to an appropriate interface of an electronic device) information from barter chain participants. The information may comprise personal information such as a user account identifier, password, payment information, location information, and the like. The information may include information related to the bartered or donated items, such as item identification information, item description information such as model, type, size, pricing or value, and the like.

An embodiment may store the information thus received, for example in a tangible memory device to build up one more repositories of information used in connection with the barter chain functionality described herein. An embodiment may also collect such information, for example via providing a downloadable application to a device. The downloadable application may include one or more templates for organizing and facilitating collection of the information that, once entered into the downloadable application (downloaded onto a participant's device, such as a mobile phone or computing device) allows an embodiment to either receive or actively collect the item information. A similar mechanism may be provided for other information, such as participant personal or account information, for example.

An embodiment may process the information, for example providing categorizing functions that organize the received information. For example, the received item information may be linked or otherwise associated to one or more stored user accounts and also analyzed for suitability with respect to one or more existing or future barter chains. Accordingly, and embodiment may receive item information and store it, before or after processing it.

An embodiment may facilitate a bartering chain's formation, progression or completion by automatically suggesting items or via offering other information to one or more participants involved in a barter chain or suggesting items to a participant in order to get them involved with a barter chain. The suggested item or items may include either items from a stored repository of donated items or items from a stored repository of barter items. An embodiment may facilitate the barter chain formation, progression or completion by actively transmitting information to one or more participants or potential participants, for example via transmission of the suggestion to a participant's device (such as a mobile phone or computing device) via a suitable network connection. Alternatively, an embodiment may provide such suggestions, including suggested matches of particular items, barter chains, or other participants to a participant's account, such as to a suggestions portion of the account such that the user, on logging into their account, may access suggestions at their discretion.

An embodiment may facilitate participant involvement by soliciting for needed items or participants, either as barter items or as donated items and like participants, to one or more users of the system. An embodiment may achieve such solicitation by mechanisms commensurate with those described above for receiving, storing and processing information and facilitating barter chains. Accordingly, and embodiment may analyze one or more barter chains, one or more participants' information, one or more repositories of items, or a suitable combination thereof, in order to actively solicit participant involvement.

As will be appreciated by one skilled in the art, various aspects may be embodied as an apparatus, system, method or program product. Accordingly, aspects may take the form of an entirely hardware embodiment or an embodiment including software that may all generally be referred to herein as a “circuit,” “module” or “system.” Furthermore, aspects may take the form of a program product embodied in one or more device readable medium(s) having device readable program code embodied therewith.

Any combination of one or more non-signal device readable medium(s) may be utilized. The non-signal medium may be a storage medium, such as a memory included in or associated with video data processing device.

Program code embodied on a non-signal storage medium may be transmitted using any appropriate medium, including but not limited to wireless, wireline, optical fiber cable, RF, et cetera, or any suitable combination of the foregoing. Program code for carrying out operations may be written in any combination of one or more programming languages. The program code may execute entirely on a single device, partly on a single device, as a stand-alone software package, or partly on single device and partly on another device. In some cases, the devices may be connected through any type of connection, either a physical (wired connection, such as over a USB connection) or via a network, including a local area network (LAN) or a wide area network (WAN), or the connection may be made through other devices (for example, through the Internet using an Internet Service Provider).

Embodiments are described with reference to figures of methods, devices, and program products. It will be understood that portions of the figures can be implemented by program instructions. These program instructions may be provided to processor(s) of a programmable data processing device to produce a machine, such that the instructions, which execute via the processor(s) of the programmable data processing device create a means for implementing the functions/acts specified.

The program instructions may also be stored in a device readable storage medium that can direct a programmable data processing device to function in a particular manner, such that the instructions stored in the storage medium produce an article of manufacture including instructions which implement the function/act specified. The program instructions may also be loaded onto a programmable data processing device to cause a series of operational steps to be performed on the programmable device to produce a process such that the instructions which execute on the programmable device provide processes for implementing the functions/acts specified.

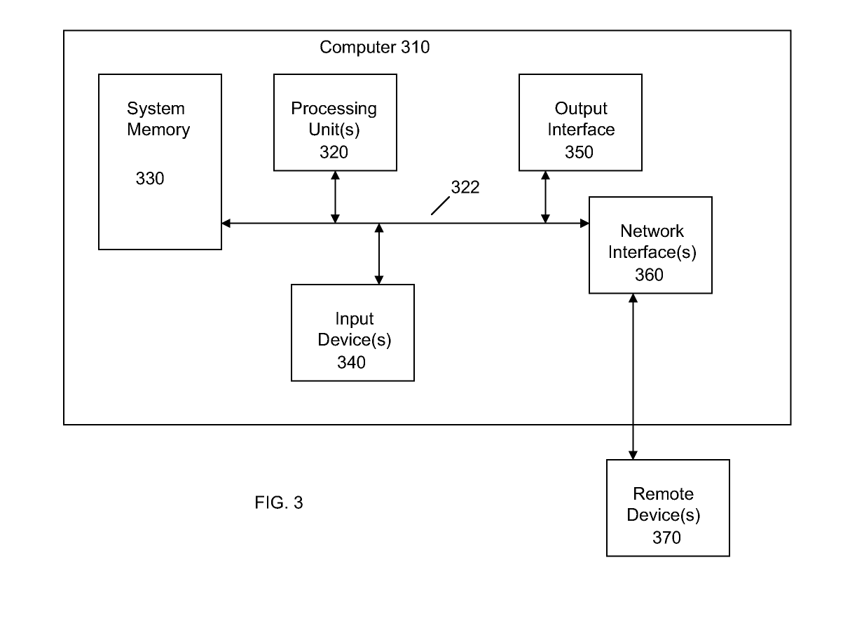

Referring now to FIG. 3, an example device that may be used in implementing one or more embodiments includes a computing device in the form of a computer 310. Components of computer 310 may include, but are not limited to, a processing unit 320, a system memory 330, and a system bus 322 that couples various system components including the system memory 330 to the processing unit 320. Computer 310 may include or have access to a variety of computer readable media. The system memory 330 may include computer readable storage media, for example in the form of volatile and/or nonvolatile memory such as read only memory (ROM) and/or random access memory (RAM). By way of example, and not limitation, system memory 230 may also include an operating system, application programs, other program modules, and program data.

A user can interface (for example, enter commands and information) into the computer 310 through input devices 340. A monitor or other type of device can also be connected to the system bus 322 via an interface, such as an output interface 350. In addition to a monitor, computers may also include other peripheral output devices. The computer 310 may operate in a networked or distributed environment using logical connections to one or more other remote device(s) 370 such as other computers. The logical connections may include network interface(s) 360 to a network, such as a local area network (LAN), a wide area network (WAN), and/or a global computer network, but may also include other networks/buses.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system comprising:
a processor;
a memory in communication with the processor; and
computer readable program executable by the processor and configured to:
receive, store, and process information from two or more participants concerning attributes of items they are interested in giving or receiving,
create a barter chain by constructing one or more barter legs that enable, based upon said information, each participant of the chain to accomplish a desired trade, donation, or receipt of one or more items through donation; and
display to each of the one or more participants information to accomplish the participant's desired trade, donation, or receipt of one or more items through donation.

2. The system of claim 1, wherein said information from the one or more participants comprises pairs of sets of sets of items.

3. The system of claim 1, wherein the barter chain ends with the last participant receiving one or more items with the last participant giving no items.

4. The system of claim 1, wherein said barter chain ends with the last participant giving one or more items to charity or one or more non-participants.

5. The system of claim 1, wherein said barter chain ends with the last participant giving one or more items he was willing to trade in consideration for the one or more items that he received, to begin a new barter chain.

6. The system of claim 1, wherein the set of items that the last participant gives to start a new barter chain includes one or more items that he received at the end of a barter chain.

7. The system of claim 1, wherein said barter chain ends with selling one or more items that the last participant was willing to trade in consideration for the one or more items the last participant received.

8. The system of claim 1, wherein a participant gives more than one item to create a barter chain leg.

9. The system of claim 1, wherein the items are commercial goods or services.

10. The system of claim 1, wherein a first participant in the barter chain gives one or more items without consideration to begin the barter chain.

11. The system of claim 1, wherein the barter market operator is a participant and gives one or more items into one or more barter chains.

12. A program product comprising:
a computer readable storage medium having computer readable program code embodied therewith, the computer readable program code configured to operate a computing device to perform acts comprising:
receiving, storing , and processing information from two or more participants concerning attributes of items the participants are interested in giving or receiving,
create a barter chain by constructing one or more barter legs that enable, based upon said information, each participant of the chain to accomplish a desired trade, donation, or receipt of one or more items through donation; and
display to each of the one or more participants information to accomplish the participant's desired trade, donation, or receipt of one or more items through donation.

13. The program product of claim 12, wherein said information from the one or more participants comprises pairs of sets of sets of items.

14. The program product of claim 12, wherein the barter chain ends with the last participant receiving one or more items with the last participant giving no items.

15. The program product of claim 12, wherein said barter chain ends with the last participant giving one or more items to charity or one or more non-participants.

16. The program product of claim 12, wherein said barter chain ends with the last participant giving one or more items he was willing to trade in consideration for the one or more items that he received, to begin a new barter chain.

17. The program product of claim 12, wherein said barter chain ends with selling one or more items that the last participant was willing to trade in consideration for the one or more items the last participant received.

18. The program product of claim 12, wherein a participant gives more than one item to create a barter chain leg.

19. The program product of claim 12, wherein a first participant in the barter chain gives one or more items without consideration to begin the barter chain.

20. The program product of claim 12, wherein the barter market operator is a participant and gives one or more items into one or more barter chains.

21. A method comprising:
receiving at an electronic device information from two or more participants concerning attributes of items for inclusion in a barter chain,
processing the information from the two or more participants concerning attributes of the items to associate the items with a barter chain;
storing the processed information in a memory device;
accessing the processed information in the memory device to create at least a barter leg of a suggested barter chain;
said suggested barter chain including one or more barter legs that comprise one or more of a trade of items, a donation of one or more items, or a receipt of one or more items through donation; and
transmitting from the electronic device to the one or more participant devices information for displaying at least a portion of the suggested barter chain.
